(19) United States
(12) Patent Application Publication
(10) Pub. No.: US 2025/0065282 A1
(43) Pub. Date: Feb. 27, 2025

(54) INTELLIGENT CONTROL-BASED DOSING AND STIRRING DEVICE FOR SEDIMENT POLLUTION CONTROL

(71) Applicant: Nanjing Institute of Environmental Sciences, MEE, Nanjing City (CN)

(72) Inventors: Xiaoshuai HANG, Nanjing City (CN); Yan WANG, Nanjing City (CN); Jing XIAO, Nanjing City (CN); Xiaohui YOU, Nanjing City (CN); Xiang CHEN, Nanjing City (CN); Dongdong ZHU, Nanjing City (CN); Lan ZHANG, Nanjing City (CN); Li ZHOU, Nanjing City (CN); Jiabao YAN, Nanjing City (CN)

(21) Appl. No.: 18/808,187

(22) Filed: Aug. 19, 2024

(30) Foreign Application Priority Data
Aug. 24, 2023 (CN) 202311072379.2

(51) Int. Cl. B01F 27/906; B01F 35/32; B01F 35/41; B01F 35/43; B01F 101/00

(52) U.S. Cl. CPC B01F 27/906; B01F 35/3214; B01F 35/4111; B01F 35/43; B01F 2101/305

(57) ABSTRACT

Provided is an intelligent control-based dosing and stirring device for sediment pollution control, including a support underframe, a support frame, a chemical cartridge, and a stirring assembly which works through intelligent control. A support ring positioned in a middle position is fixed into the support underframe by multiple support rods, and an anti-shaking mechanism is arranged in the support ring, and mounted in the support ring by multiple shock-absorbing assemblies. The shock-absorbing assemblies are used for shock absorption, thus preventing the chemical cartridge from shaking. The anti-shaking mechanism includes a circular support block, and an annular groove is formed in the circular support block. The intelligent control-based dosing and stirring device for sediment pollution control relates to the technical field of dosing and stirring devices.

### CROSS-REFERENCE TO RELATED APPLICATION

This patent application claims the benefit and priority of Chinese Patent Application No. 202311072379.2, filed with the China National Intellectual Property Administration on Aug. 24, 2023, the disclosure of which is incorporated by reference herein in its entirety as part of the present application.

### TECHNICAL FIELD

The present disclosure relates to the technical field of dosing and stirring devices, and in particular to an intelligent control-based dosing and stirring device for sediment pollution control.

### BACKGROUND

The level of pollution of channel reservoirs in cities is increasing day by day, mainly due to the leachate generated by garbage accumulation around the reservoir, the leakage of domestic sewage from sewage pipes around the reservoir, and the initial rainwater flowing into the reservoir water. When the input of pollutants exceeds the self-purification ability of the reservoir, some pollutants are deposited at the bottom of the reservoir, which leads to the secondary release of pollutants from the sediment and the repeated deterioration of water quality. The existing the main methods for sediment treatment are in-situ treatment and ex-situ treatment. In-situ treatment technology is to treat sludge in situ. The in-situ treatment technology can avoid the high cost of sludge transfer and secondary pollution and the loss of reservoir sediment by treating the sediment in situ. The existing in-situ treatment technology is mainly to add sediment-improving chemicals to the sediment, which are used to remove reducing substances in the water by oxidation, and degrade or absorb nitrogen, phosphorus and other elements, thus solving the problem of sediment pollution.

Before adding the improving chemicals into the reservoir, the chemicals need to be formulated, so it is necessary to use a dosing and stirring device for sediment pollution control to proportion the chemicals and add the proportioned chemicals into the reservoir. When the existing dosing and stirring device is used, the chemicals are stirred and mixed by the rotation of the stirring blade. However, the chemical cartridge for carrying the chemicals is usually only placed on the support frame, and the cartridge may shake when the chemicals are stirred and driven to rotate. Generally, such shaking is avoided by the weight of the chemical cartridge and the chemicals, but the greater the amount of the chemicals, the greater the force generated by the rotation, which cannot fundamentally solve the generation of shaking. In addition, the existing stirring blade is fixed to the rotating shaft by a bolt, and if the stirring blade needs to be replaced, the operation is more troublesome.

### SUMMARY

For the shortcomings in the prior art, an intelligent control-based dosing and stirring device for sediment pollution control is provided, which solves the problems that the existing dosing and stirring device for sediment pollution control shakes during the stirring of chemicals and the stirring blade is inconvenient to replace.

To achieve the objective above, the present disclosure is implemented through the following technical solution. An intelligent control-based dosing and stirring device for sediment pollution control includes a support underframe, a support frame, a chemical cartridge, and a stirring assembly which works through intelligent control. A support ring positioned in a middle position is fixed into the support underframe by multiple support rods, the support ring is internally provided with an anti-shaking mechanism to prevent the chemical cartridge from shaking. The anti-shaking mechanism is mounted in the support ring by multiple shock-absorbing assemblies which are used for shock absorption. The anti-shaking mechanism includes a circular support block, and an annular groove is formed inside the circular support block. A cross-shaped groove is formed in a middle position in the circular support block, and four racks are in sliding connection with an inner surface of the cross-shaped groove. Four transmission gears are rotatably connected to the bottom of an inner wall of the annular groove at equal distance. An inner surface of the annular groove in sliding connection with an annular gear, and the annular gear is in meshing transmission with the four transmission gears. The four racks are in meshing transmission with the transmission gears at corresponding positions, respectively.

Preferably, a drive motor is fixedly connected to the bottom of the circular support block, and an output end of the drive motor runs through the circular support block and extends into the annular groove. A driving gear is fixedly connected to the output end of the drive motor, and the driving gear is in meshing transmission with the annular gear.

Preferably, a fixed block is fixedly connected to the top of each of the four racks, and the fixed block runs through the circular support block and extends to a position above the circular support block. A cambered plate is fixedly connected to the top of each of the four fixed blocks.

Preferably, the shock-absorbing assembly includes multiple arc-shaped grooves formed in an inner surface of the support ring at equal distance, and multiple connecting blocks are fixedly connected to an annular surface of the circular support block at equal distance. The multiple connecting blocks are in sliding connection with the arc-shaped grooves at corresponding positions, respectively.

Preferably, a damper is rotatably connected to an inner wall of the arc-shaped groove, an output end of the damper is rotatably connected to one side of the connecting block, a surface of the damper is sleeved with a buffer spring, and both ends of the buffer spring are in contact with the inner wall of the arc-shaped groove and a side surface of the connecting block, respectively.

Preferably, the stirring assembly includes an input motor, a rotating shaft, and a stirring blade. The stirring blade is mounted on the rotating shaft by a mounting assembly. The mounting assembly includes a mounting groove formed in a bottom end of the rotating shaft, and a mounting rod. A groove is formed in a top end of the mounting rod, a circular plate is in sliding connection with an inner surface of the groove, a first reset spring is fixedly connected to the bottom of the circular plate, and the other end of the first reset spring is fixedly connected to the bottom of the inner wall of the groove.

Preferably, a limiting groove is formed in each of a front face and a back face of the mounting rod, a limiting post in fit with the limiting groove is arranged on each of a front face and a back face of an inner wall of the mounting groove, and a clamping groove is formed in a top edge of the circular plate.

Preferably, a left L-shaped rod and a right L-shaped rod are in sliding connection with left and right sides of the rotating shaft by chutes, respectively. A downward bent end of each of the two L-shaped rods extends into the mounting groove, and the other end of the two L-shaped rods is fixedly connected to a shifting ring. A second reset spring is fixedly connected between the bottom of the L-shaped rod and the bottom of an inner wall of the chute.

The present disclosure has the beneficial effects that:

The present disclosure provides an intelligent control-based dosing and stirring device for sediment pollution control. Compared with the prior art, the present disclosure has the following beneficial effects:

1. According to the intelligent control-based dosing and stirring device for sediment pollution control provided by the present disclosure, the chemical cartridge is clamped and fixed by the anti-shaking mechanism arranged on the support underframe, thus preventing the chemical cartridge from shaking when a centrifugal force is generated during dosing and stirring. The clamping operation for the chemical cartridge is convenient, the chemical cartridges with different sizes can be fixed, and the convenience during the use of the device is improved.

2. According to the intelligent control-based dosing and stirring device for sediment pollution control provided by the present disclosure, the shock-absorbing assembly is arranged at the periphery of the circular support block to absorb the force generated by stirring the chemicals, thus avoiding the problem of position deviation of the whole supporting underframe caused by excessive force.

3. According to the intelligent control-based dosing and stirring device for sediment pollution control provided by the present disclosure, the stirring blade is mounted on the rotating shaft by the mounting assembly. When the mounting assembly is used to mount the stirring blade, the stirring blade can be simply and rapidly mounted only by pressing and rotating once.

### BRIEF DESCRIPTION OF THE DRAWINGS

FIG. 1 is an appearance diagram of the present disclosure;

FIG. 2 is a top view of a support underframe according to the present disclosure;

FIG. 3 is a cross-sectional diagram of a support ring according to the present disclosure;

FIG. 4 is a cutaway view of an anti-shaking mechanism according to the present disclosure;

FIG. 5 is a sectional view of an anti-shaking mechanism according to the present disclosure;

FIG. 6 is a sectional view of a chemical cartridge according to the present disclosure;

FIG. 7 is a partial sectional view of a mounting assembly according to the present disclosure;

FIG. 8 is an enlarged view of position A according to the present disclosure;

FIG. 9 is a cross-sectional diagram of a rotating shaft and a mounting rod according to the present disclosure.

In the drawings: 1—support underframe; 11—support ring; 12—support rod; 2—support frame; 3—chemical cartridge; 4—stirring assembly; 5—anti-shaking mechanism; 51—circular support block; 52—annular groove; 53—cross-shaped groove; 54—rack; 55—transmission gear; 56—annular gear; 57—drive motor; 58—driving gear; 59—cambered plate; 6—shock-absorbing assembly; 61—arc-shaped groove; 62—connecting block; 63—damper; 64—buffer spring; 7—rotating shaft; 8—mounting assembly; 81—mounting groove; 82—mounting rod; 83—groove; 84—circular plate; 85—first reset spring; 86—limiting groove; 87—limiting post; 88—L-shaped rod; 89—shifting ring; 810—second reset spring; 811—clamping groove.

### DETAILED DESCRIPTION OF THE EMBODIMENTS

The following clearly and completely describes the technical solutions in the embodiments of the present disclosure with reference to the accompanying drawings in the embodiments of the present disclosure. Apparently the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An intelligent control-based dosing and stirring device for sediment pollution control provided three technical solutions.

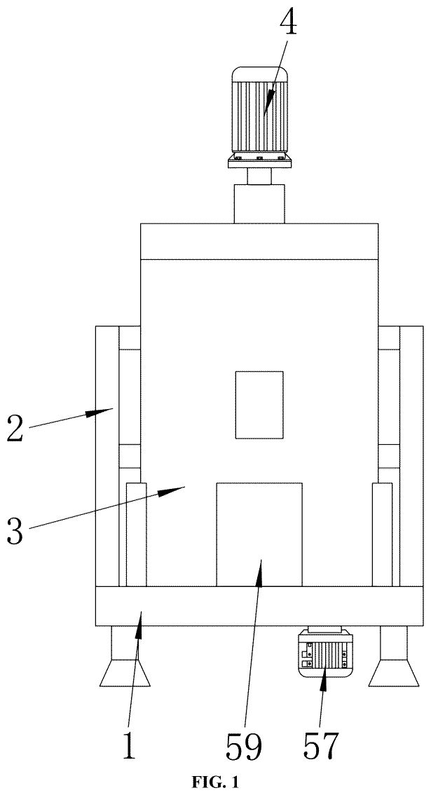

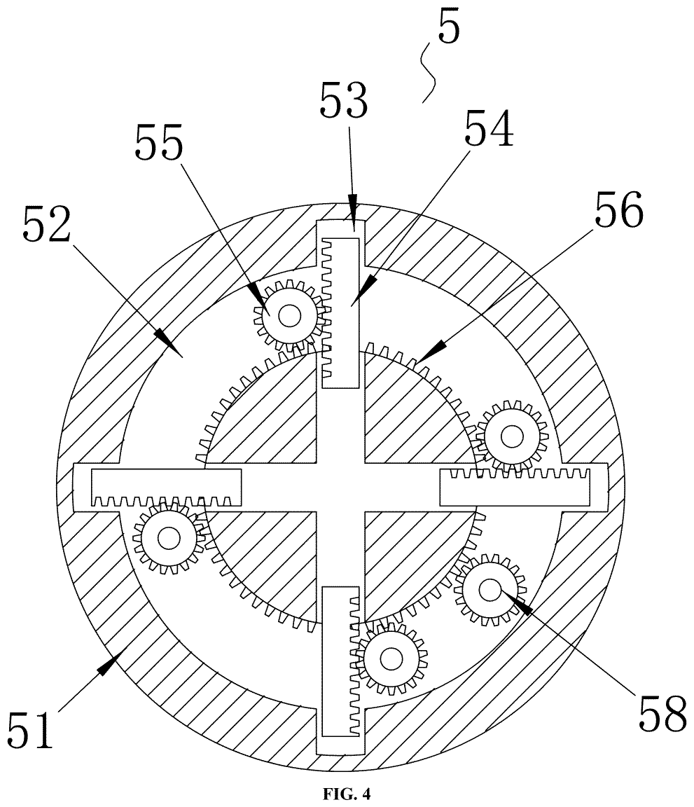

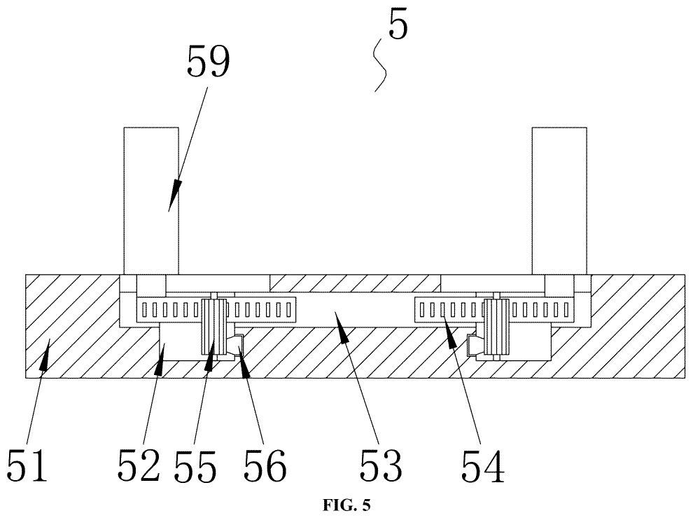

A first embodiment is shown in FIG. 1 to FIG. 5, the intelligent control-based dosing and stirring device for sediment pollution control includes a support underframe 1, a support frame 2, a chemical cartridge 3, and a stirring assembly 4. A pressure pump, a conveying pipeline and a control box body are mounted on the support frame 2. A controller is arranged in a control box and used to control the start/stop of the whole device and to intelligently control the dose. A support ring 11 positioned in a middle position is fixed into the support underframe 1 by multiple support rods 12, the support ring 11 is internally provided with an anti-shaking mechanism 5 to prevent the chemical cartridge 3 from shaking. The anti-shaking mechanism 5 is mounted in the support ring 11 by multiple shock-absorbing assemblies 6 which are used for shock absorption. The anti-shaking mechanism 5 includes a circular support block 51, and an annular groove 52 is formed in the circular support block 51. A cross-shaped groove 53 is formed in a middle position in the circular support block 51, and four racks 54 are in sliding connection with an inner surface of the cross-shaped groove 53. Four transmission gears 55 are rotatably connected to the bottom of an inner wall of the annular groove 52 at equal distance. An inner surface of the annular groove 52 in sliding connection with an annular gear 56, and the annular gear 56 is in meshing transmission with the four transmission gears 55. The four racks 54 are in meshing transmission with the transmission gears 55 at corresponding positions, respectively. A drive motor 57 is fixedly connected to the bottom of the circular support block 51, and an output end of the drive motor 57 runs through the circular support block 51 and extends into the annular groove 52. A driving gear 58 is fixedly connected to the output end of the drive motor 57, and the driving gear 58 is in meshing transmission with the annular gear 56 A fixed block is fixedly connected to the top of each of the four racks 54, and the fixed block runs through the circular support block 51 and extends to a position above the circular support block 51. A cambered plate 59 is fixedly connected to the top of each of the four fixed blocks.

The chemical cartridge 3 is clamped and fixed by the anti-shaking mechanism arranged on the support underframe 5, such that the position of the chemical cartridge 3 can be fixed when the chemicals are stirred, thus preventing the chemical cartridge 3 from shaking caused by the centrifugal force generated by stirring. Moreover, the clamping operation for the chemical cartridge 3 is convenient, the chemical cartridges 3 with different sizes can be fixed, and the convenience during the use of the device is improved.

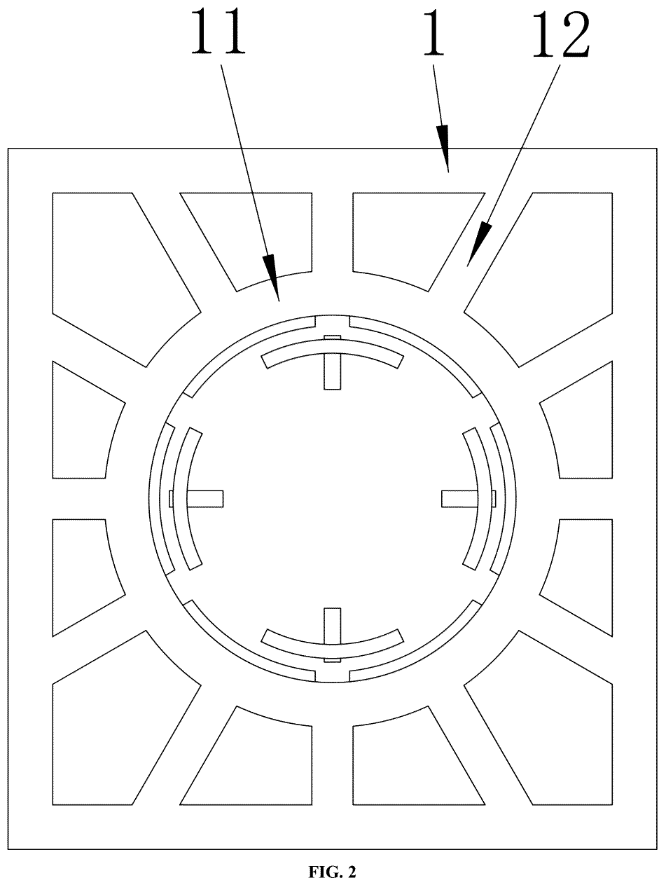

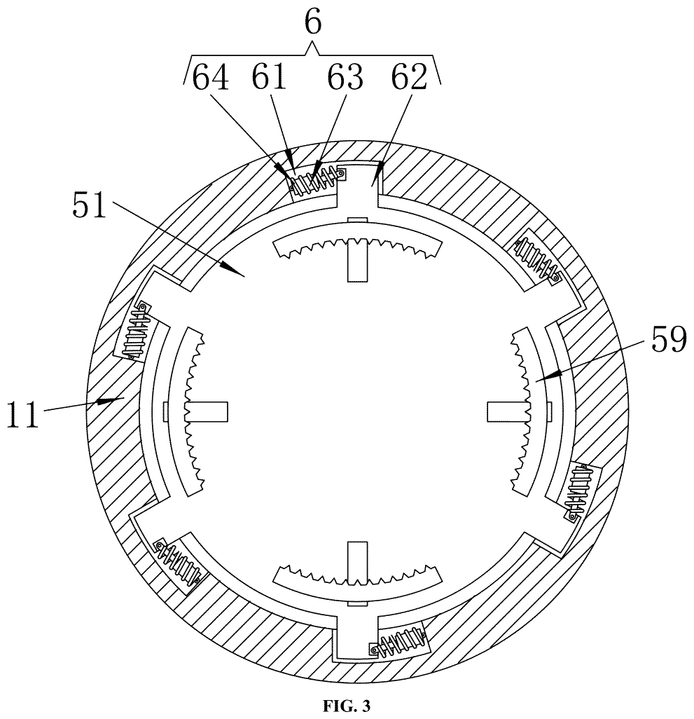

A second embodiment is shown in FIG. 2 and FIG. 3, the main difference from the first embodiment is that the shock-absorbing assembly 6 includes multiple arc-shaped grooves 61 formed in an inner surface of the support ring 11 at equal distance. Multiple connecting blocks 62 are fixedly connected to an annular surface of the circular support block 51 at equal distance, and the multiple connecting blocks 62 are in sliding connection with the arc-shaped grooves 61 at corresponding positions, respectively. A damper 63 is rotatably connected to an inner wall of the arc-shaped groove 61, an output end of the damper 63 is rotatably connected to one side of the connecting block 62, and a surface of the damper 63 is sleeved with a buffer spring 64. Both ends of the buffer spring 64 are in contact with the inner wall of the arc-shaped groove 61 and a side surface of the connecting block 62, respectively.

The shock-absorbing assembly 6 is arranged at the periphery of the circular support block 51 to absorb the force generated by stirring the chemicals, thus avoiding the problem of position deviation of the whole supporting underframe 2 caused by excessive force.

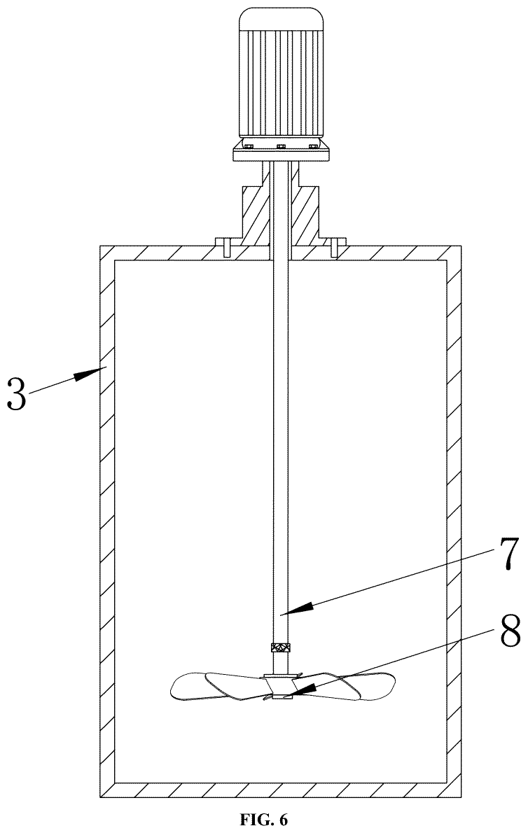

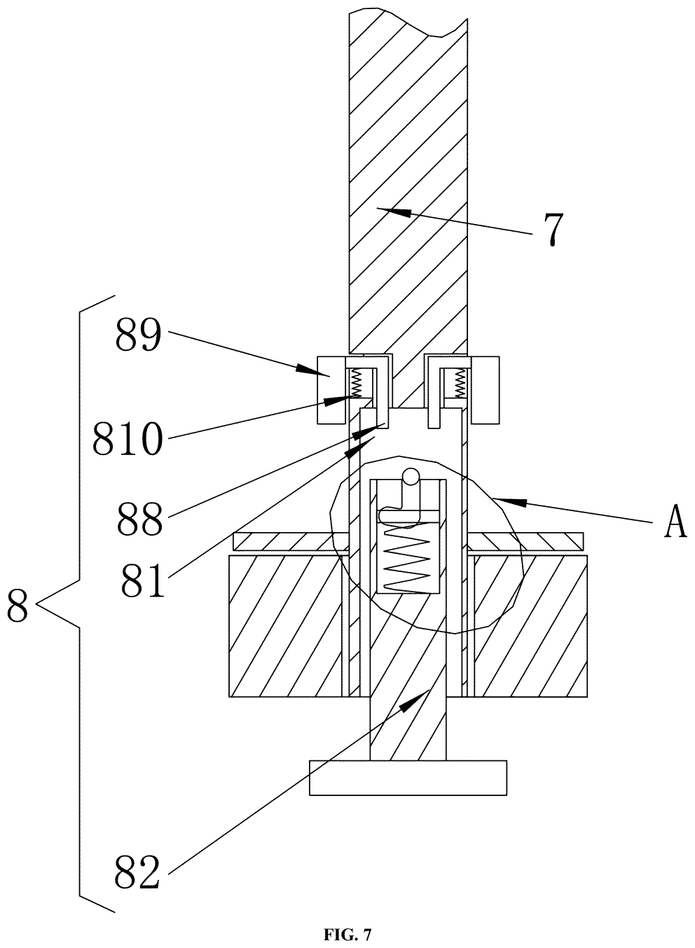

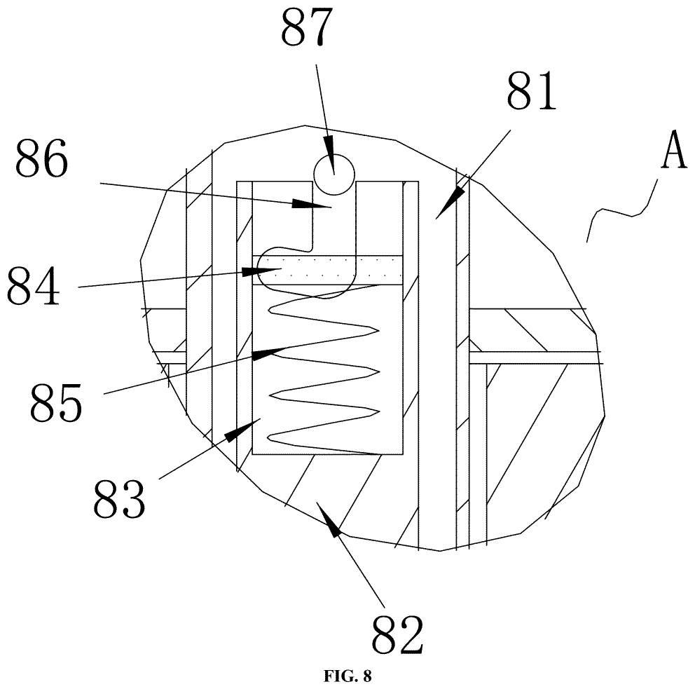

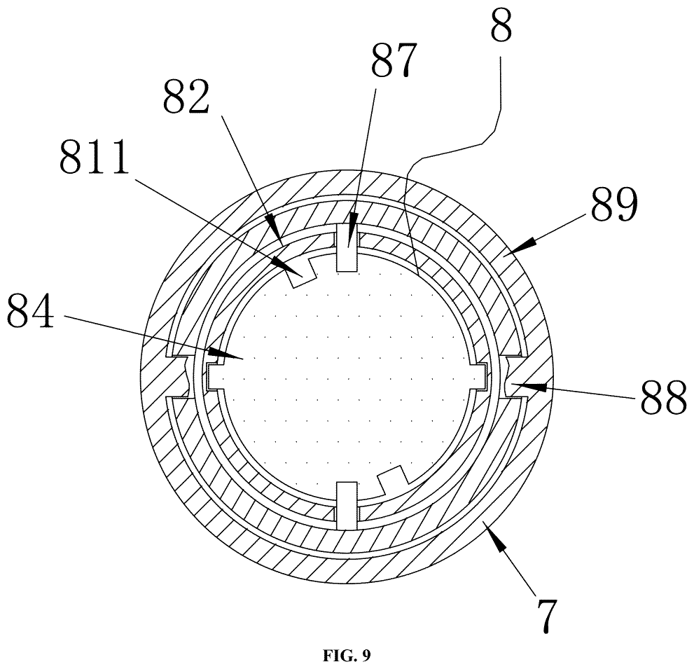

A third embodiment is shown in FIG. 6 to FIG. 9, the main difference from the second embodiment is that a stirring assembly 4 includes an input motor, a rotating shaft 7, and a stirring blade. The stirring blade is mounted on the rotating shaft 7 by a mounting assembly 8. The mounting assembly 8 includes a mounting groove 81 formed in a bottom end of the rotating shaft 7, and a mounting rod 82. A groove 83 is formed in a top end of the mounting rod 82, a circular plate 84 is in sliding connection with an inner surface of the groove 83, a first reset spring 85 is fixedly connected to the bottom of the circular plate 84, and the other end of the first reset spring 85 is fixedly connected to the bottom of the inner wall of the groove 83. A limiting groove is formed in each of a front face and a back face of the mounting rod 82. A limiting post in fit with the limiting groove is arranged on each of a front face and a back face of an inner wall of the mounting groove 81, and a clamping groove is formed in a top edge of the circular plate 84. A left L-shaped rod 88 and a right L-shaped rod 88 are in sliding connection with left and right sides of the rotating shaft 7 by chutes, respectively. A downward bent end of each of the two L-shaped rods 88 extends into the mounting groove 81, and the other end of the two L-shaped rods 88 is fixedly connected to a shifting ring 89. A second reset spring 810 is fixedly connected between the bottom of the L-shaped rod 88 and the bottom of an inner wall of the chute.

The stirring blade is mounted on the rotating shaft 7 by the mounting assembly 8. When the mounting assembly 8 is used to mount the stirring blade, the stirring blade can be simply and rapidly mounted only by pressing and rotating once.

During mounting, the chemical cartridge 3 is placed at the top of the circular support block 51, the drive motor 57 is started to drive the driving gear 58 to rotate, the driving gear 58 rotates, and the rotation of the driving gear 58 is transmitted to the annular gear 56. The annular gear 56 rotates, and the rotation of the annular gear 56 is transmitted to the transmission gear 55. The transmission gear 55 rotates to make the rack 54 move, the rack 54 moves to drive the cambered plate 59 to move close to the outside of the chemical cartridge 3 and clamp the outside of the chemical cartridge 3. At this time, the mounting of the chemical cartridge 3 is completed. When the stirring assembly 4 works to stir chemicals in the chemical cartridge 3, a generated force is first transmitted to the circular support block 51, the circular support block 51 generates a shake tendency which is transmitted to the connecting block 62, such that the buffer spring 64 is compressed, and the damper 63 is used for shock absorption and absorbing the transmitted force. In addition, during the mounting of the stirring blade, the stirring blade is sleeved at the bottom end of the rotating shaft 7, and the mounting rod 82 is mounted in the mounting groove 82, and the mounting rod 82 moves towards the inside of the mounting groove 81. The limiting post 87 enters a vertical portion of the limiting groove 86, and after the limiting post 87 reaches the bottom, the mounting rod 82 is rotated to make the limiting post 87 enter an inclined portion of the limiting groove 86, such that the mounting rod 82 can move upwards to press against the stirring blade. In addition, when the limiting post 87 enters the end of the inclined portion of the limiting groove 86, the limiting post 87 enters the clamping groove 811 on the circular plate 84, thereby limiting the whole mounting rod 82 and preventing rotation. When disassembling, the shifting ring 89 is rotated downwards to make the L-shaped rod 88 in contact with the circular plate 84, such that the clamping groove 811 is separated from the limiting post 87. At this time, the mounting rod 82 can be rotated and pulled out, thus completing the disassembling of the stirring blade.

It should be noted that relational terms such as first and second herein are only used to distinguish one entity or operation from another entity or operation without necessarily requiring or implying any such actual relationship or order between these entities or operations. Moreover, the terms “comprise”, “include” or any other variation thereof are intended to cover non-exclusive inclusion, making a process, method, article or equipment including a series of elements include not only those elements, but also other elements not explicitly listed, or elements inherent to such process, method, article or equipment.

Although the embodiments of the present disclosure have been shown and described, those skilled in the art can understand that many changes, modifications, substitutions and variations can be made to these embodiments without departing from the principles and purposes of the present disclosure, and the scope of the present disclosure is defined by the claims and their equivalents.

What is claimed is:

1. An intelligent control-based dosing and stirring device for sediment pollution control, comprising a support underframe (1), a support frame (2), a chemical cartridge (3), and a stirring assembly (4) which works through intelligent control, wherein a support ring (11) positioned in a middle position is fixed into the support underframe (1) by a plurality of support rods (12), the support ring (11) is internally provided with an anti-shaking mechanism (5) to prevent the chemical cartridge (3) from shaking; the anti-shaking mechanism (5) is mounted in the support ring (11) by a plurality of shock-absorbing assemblies (6) which are used for shock absorption; the anti-shaking mechanism (5) comprises a circular support block (51), and an annular groove (52) is formed inside the circular support block (51); a cross-shaped groove (53) is formed in a middle position in the circular support block (51), and four racks (54) are in sliding connection with an inner surface of the cross-shaped groove (53); four transmission gears (55) are rotatably connected to the bottom of an inner wall of the annular groove (52) at equal distance; an inner surface of the annular groove (52) in sliding connection with an annular gear (56), and the annular gear (56) is in meshing transmission with the four transmission gears (55); and the four racks (54) are in meshing transmission with the transmission gears (55) at corresponding positions, respectively.

2. The intelligent control-based dosing and stirring device for sediment pollution control according to claim 1, wherein a drive motor (57) is fixedly connected to the bottom of the circular support block (51), an output end of the drive motor (57) runs through the circular support block (51) and extends into the annular groove (52), a driving gear (58) is fixedly connected to the output end of the drive motor (57), and the driving gear (58) is in meshing transmission with the annular gear (56).

3. The intelligent control-based dosing and stirring device for sediment pollution control according to claim 1, wherein a fixed block is fixedly connected to the top of each of the four racks (54), and the fixed block runs through the circular support block (51) and extends to a position above the circular support block (51); and a cambered plate (59) is fixedly connected to the top of each of the four fixed blocks.

4. The intelligent control-based dosing and stirring device for sediment pollution control according to claim 1, wherein the shock-absorbing assembly (6) comprises a plurality of arc-shaped grooves (61) formed in an inner surface of the support ring (11) at equal distance, a plurality of connecting blocks (62) are fixedly connected to an annular surface of the circular support block (51) at equal distance, and the plurality of connecting blocks (62) are in sliding connection with the arc-shaped grooves (61) at corresponding positions, respectively.

5. The intelligent control-based dosing and stirring device for sediment pollution control according to claim 4, wherein a damper (63) is rotatably connected to an inner wall of the arc-shaped groove (61), an output end of the damper (63) is rotatably connected to one side of the connecting block (62), a surface of the damper (63) is sleeved with a buffer spring (64), and both ends of the buffer spring (64) are in contact with the inner wall of the arc-shaped groove (61) and a side surface of the connecting block (62), respectively.

6. The intelligent control-based dosing and stirring device for sediment pollution control according to claim 1, wherein the stirring assembly (4) comprises an input motor, a rotating shaft (7), and a stirring blade; the stirring blade is mounted on the rotating shaft (7) by a mounting assembly (8); the mounting assembly (8) comprises a mounting groove (81) formed in a bottom end of the rotating shaft (7), and a mounting rod (82); a groove (83) is formed in a top end of the mounting rod (82), a circular plate (84) is in sliding connection with an inner surface of the groove (83), a first reset spring (85) is fixedly connected to the bottom of the circular plate (84), and the other end of the first reset spring (85) is fixedly connected to the bottom of the inner wall of the groove (83).

7. The intelligent control-based dosing and stirring device for sediment pollution control according to claim 6, wherein a limiting groove is formed in each of a front face and a back face of the mounting rod (82), a limiting post in fit with the limiting groove is arranged on each of a front face and a back face of an inner wall of the mounting groove (81), and a clamping groove is formed in a top edge of the circular plate (84).

8. The intelligent control-based dosing and stirring device for sediment pollution control according to claim 6, wherein a left L-shaped rod (88) and a right L-shaped rod (88) are in sliding connection with left and right sides of the rotating shaft (7) by chutes, respectively; a downward bent end of each of the two L-shaped rods (88) extends into the mounting groove (81), and the other end of the two L-shaped rods (88) is fixedly connected to a shifting ring (89); and a second reset spring (810) is fixedly connected between the bottom of the L-shaped rod (88) and the bottom of an inner wall of the chute.
